(19) United States
(12) Patent Application Publication
(10) Pub. No.: US 2008/0149687 A1
(43) Pub. Date: Jun. 26, 2008

(54) Weld Inspection Optimizer

(76) Inventors: Mark D. Garnett, Oakland, MI (US); James R. Norman, Chesterfield, MI (US); Aimee E. Brown, Waterville, OH (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/615,308

(22) Filed: Dec. 22, 2006

(51) Int. Cl. B23K 31/02

(52) U.S. Cl. 228/104

(57) ABSTRACT

A method for inspecting welds comprising sorting a plurality of welds to be inspected according to a weld device that made the welds. After sorting the welds according to the weld device that made the welds, the welds are sorted according to a plurality of weld schedules at which the weld devices made the welds. Then, the welds are sorted according to a weld number. Subsequently, at least one weld made by each weld device is inspected, and the process is repeated until every weld made by each weld device at each weld setting is inspected.

### FIELD OF THE INVENTION

The present invention relates to a weld inspection method and system.

### BACKGROUND OF THE INVENTION

Welding is becoming more complex in the automotive industry due to different material technologies and product flexibility. Accordingly, it is becoming increasingly difficult to monitor each of the devices making the welds, and difficult to monitor the quality of the welds themselves. Currently, inspection methods vary from plant to plant, and inspectors generally only make random inspections of vehicles and assemblies. This is troublesome because if, for example, a welding device begins to make unsatisfactory welds, the unsatisfactory welds may not be discovered for some time. Further, these inspection methods may result in the same weld being inspected multiple times on multiple units. This may then result in a multiple vehicles being manufactured with unsatisfactory welds. Accordingly, there is a need for a systematic weld inspection method that controls how and when welds are inspected.

### SUMMARY OF THE INVENTION

The present teachings provide a method for inspecting welds comprising of sorting a plurality of welds to be inspected according to a weld device that made the welds. After sorting the welds according to the weld device that made the welds, the welds are sorted according to a plurality of weld schedules at which the weld devices made the welds. Then, the welds are sorted according to a weld number. Subsequently, at least one weld made by each weld device is inspected, and the process is repeated until every weld made by each weld device at each weld schedule is inspected.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic representation of various devices used in conjunction with the weld inspection method of the present teachings; and

FIGS. 2 through 6 illustrate exemplary screens that may be used with a software program that performs the methods of the present teachings.

### DETAILED DESCRIPTION OF THE PREFERRED EMBODIMENTS

The following description of the preferred embodiment(s) is merely exemplary in nature and is in no way intended to limit the invention, its application, or uses.

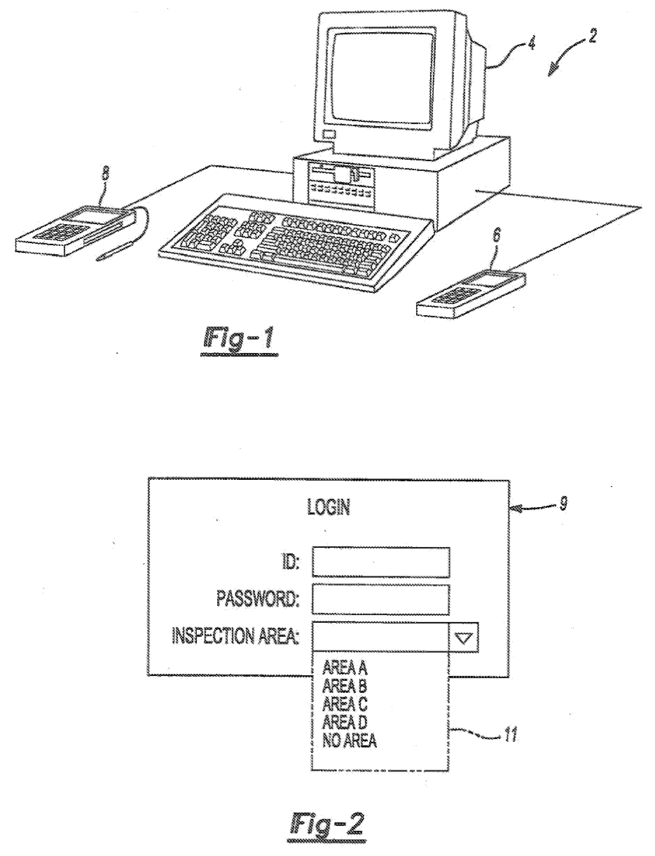

The present teachings relate to a system that optimizes weld inspections. In other words, the present teachings relate to a system that assists in optimizing how and when welds made by various weld devices are inspected. As illustrated in FIG. 1, the system 2 may include a computer 4 or some other device capable of running software programs. For example, the program may run on a remote device 6 such as a personal digital assistant (PDA) or a weld-analyzing tool 8. Examples of a weld-analyzing tool 8 are an ultrasonic weld inspection tool, an electrical resistance weld inspection tool, a thermographic weld inspection tool, an eddy current weld inspection tool, and a tool that uses x-rays to inspect a weld. It should be understood, however, that any type of weld-analyzing device 8 that is capable of running a software program may be used without departing from the spirit and scope of the present teachings.

Data taken with the remote device 6 or tool 8 may be downloaded to the computer 4 by docking the device 6 or tool 8 to the computer 4, or downloaded to a computer 4 over a wireless network. In this manner, the data may be downloaded and then transferred, printed, saved, archived, or used in any way desired. Further, reports may be generated for the recorded weld inspection data, as well as generated for inspection data that may be missing (i.e., data that has not be recorded). Regardless, it should be understood that the present teachings enable easier storage, organization, and transfer of weld inspection data.

To optimize how and when welds made by various weld devices are inspected, the criteria of the weld inspections must first be entered into the system's 2 database. As a first criteria, each of the welds made in a manufacturing plant should be divided into a plurality of inspection groups. Each group may be assigned a name, letter, or number that corresponds to each inspection group.

The inspection groups of the manufacturing plant may also be organized according to the types of inspections that will be conducted in each inspection area. In this regard, various inspection types include whether the inspection is performed off-line or in-line. Alternatively, the inspection areas may be organized according to which weld line is to be checked. In this regard, a plurality of weld lines may be in each inspection area.

Various weld information may also be entered into the program's database. This information includes the model number or assembly where the welds are to be placed, the weld number, device number, and weld schedule number. With respect to the weld number, it should be understood that each assembly may include a plurality of welds. Accordingly, each weld on each assembly may be assigned a number that may be entered into the database.

With respect to device number, it is not uncommon for a plurality of weld devices to make various welds on a single assembly. Weld devices include, resistance spot welding guns, laser weld devices, friction stir welding devices, and other devices known to one skilled in the art. Each weld made by a single device, therefore, may also be criteria that is monitored and managed by the optimization program of the present teachings. Further, since a plurality of devices are making a plurality of welds on a single assembly, it is not uncommon for the various devices to make welds at various weld schedules.

A weld schedule is a group of weld process parameters including weld force, weld current, and weld time. Other parameters, however, may also be considered. Regardless, it should be understood that one weld device may make a weld using one set of process parameters while another device makes welds using other process parameters. The weld schedules used for each device, therefore, may also be included in the optimization program database.

Other basic criteria that may be tracked and managed by the database are the weld classification, type and thickness of substrates in a weld stack-up, and the inspection method used to inspect the assemblies. Weld classification include a ranking assigned to each weld according to the weld's structural importance, criticality, or weld type. Stack-ups include either 2 t or 3 t (i.e., two-substrate or three-substrate) thicknesses. Inspection methods include, but are not limited to, chisel inspections, ultrasonic inspections, resistance inspections, thermographic inspections, eddy current inspections, x-ray inspections, and visual inspections.

Regardless which inspection methods is used, the inspector looks for whether the weld has any pinholes or cracks, and whether the weld is distorted, off-location, or has excessive indentation. This data may then be entered into the program to track whether the weld device is satisfactorily making its various welds. Moreover, the program of the present teachings is capable of displaying a graphic or picture showing each weld location, along with a brief description of each of the welds in each location. For example, an assembly may be divided into a plurality of zones that are each assigned a number (e.g., 1-10). The numbers may be used to group welds together that are located near each other in each zone. Alternatively, the welds may be assigned to various zones.

Each zone, or, alternatively, each weld of each zone, may also be assigned an odd or even number. For example, odd numbers may be assigned to zones or welds formed on an assembly that will be placed on a left side of a vehicle or assembly, while even numbers may assigned to welds that are formed on an assembly that will placed on a right side of the vehicle or assembly. In this manner, the inspector is prevented from having to switch back and forth from one side of the vehicle or assembly to the other during the inspections.

According to the present teachings, in general, the program prioritizes the order in which welds are inspected. Firstly, the program will sort all welds by the device that makes the weld, then by the weld schedule that the weld device uses to make the weld, and then by the weld number. One weld will be checked from each device. Once a weld from each device has been checked, the program will re-start at the beginning of the device list and pick a weld from the next weld schedule on each device. The program will repeat this process, and once a weld has been checked on all schedules on an individual device, the program will select the next weld number at the first schedule for that device. The program will continue to repeat this process until all welds are eventually inspected.

Variations that depart from the above method may also be used. For example, as stated above, the welds may also be categorized by a zone (e.g., 1-10). Using these zones as a template, the program can set an inspection route where welds formed in each zone are checked. Once the welds in that zone are checked, the program will select the next zone for inspection. Inspecting the welds in this manner also prevents the inspector from continuously looking all over the unit or panel being inspected for various welds. Another variation is that each time a 3 t weld is to be checked, the program will prompt the inspector to check either the front or back side of the weld. If the front side of the weld is checked, for example, the next time that weld is checked, the inspector will be prompted to check the back side of the weld. Alternatively, the system can prompt the inspector to simply inspect the side of the 3 t weld that is more prone to having a weld quality issue. Regardless, it should be understood that the program according to the present teachings provides a method of inspecting each weld made by a plurality of weld devices in a systematic manner.

If a discrepant weld is found and this information is input into the program, the program may prompt the inspector to inspect every weld made from that weld device. Further, the program may prompt the discrepant weld be checked on the subsequent assemblies. In addition, the program and method of the present teachings may provide the inspector with historical data regarding the discrepant weld and device. In this manner, the source of the discrepant weld may be found and corrected in a more efficient manner. Further, if the inspector is not to perform the more thorough inspection of every weld from that weld device, or inspect the next two assemblies, the program of the present teachings enables the data regarding the discrepant weld to be printed or forwarded to the individual or group that will perform the more thorough inspection.

If the inspector is performing in-line inspections, the program may also prompt the inspector to perform a visual inspection of every weld located in one zone after a predetermined number of assemblies have been inspected. In this regard, the program may show a graphic of all the welds in the pre-selected zone. The inspector will then visually check all the welds in that zone. The inspection zone may also rotate over time as determined by the program. In this manner, the inspector is freed from performing the same task repeatedly and a more thorough inspection of the welds of each zone can be made.

A more detailed description of the program and method of the present teachings will now be described with reference to the drawings. It should be understood, however, that the following description, particularly the drawings, are merely exemplary in nature. In this regard, the screens of the program may be adapted to illustrate the desired information in many different ways. It should also be understood that the various inspection criteria described above has already been input into the weld inspection program.

As shown in FIG. 2, to open the optimization program the user or inspector must enter a log-in ID and password. Furthermore, the log-in screen 9 may require the user to choose an inspection area. Each of these areas may be found from pull-down list 11 of all the inspection areas. The inspector also has the ability to choose “no area” if a random inspection of units is desired. If an inspection area is selected, the possible models and weld lines for that inspection area will be populated automatically by the optimization program. It should be understood that the screen 9 illustrated in FIG. 2 will be displayed each time the inspector or user logs into the optimization program.

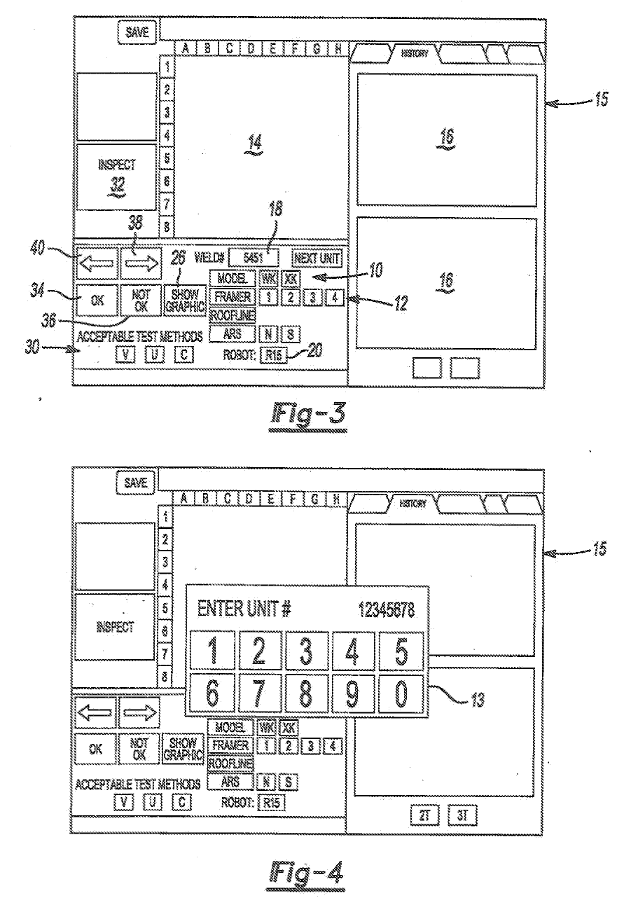

As shown in FIG. 3, the inspector will be prompted to choose the model number of the unit he is inspecting by either touching or clicking the appropriate buttons 10. The model possibilities, as stated above, were populated automatically after the inspector selected the desired inspection area during the log-in process. The inspector will also be prompted to select the weld lines that the units came by either touching or clicking the appropriate buttons 12. The possible weld lines are also populated automatically after the inspector chooses his inspection area.

Then, as shown in FIG. 4, the inspector will be prompted to input the first sequence number (unit number) to be inspected. Graphics of the assembly including the location of its welds, and the historical data of the welds and their corresponding weld devices may be displayed by the program. The screen will also display the first weld to inspect.

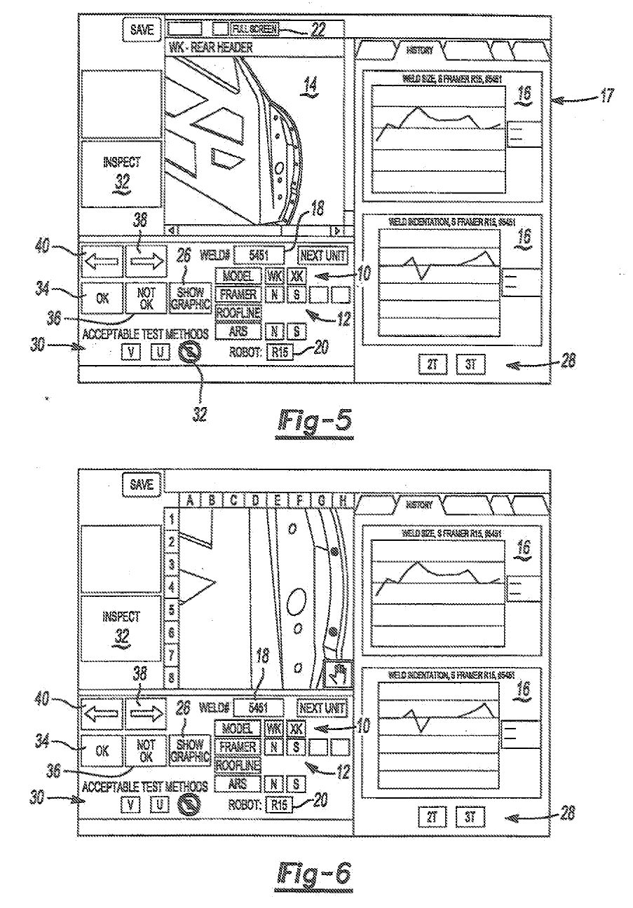

After inputting the appropriate sequence number, the screen 17 shown in FIG. 5 will appear. FIG. 5 is similar to FIG. 3, except a plurality of information display panels 14 and 16 now depict various information. A main graphic display panel 14, as illustrated in FIG. 5, may be used to show a graphic of the unit to be inspected. Alternatively, however, the main graphic display panel 14 may also be used to display any information taken with the appropriate weld inspection device (e.g., a graph depicting various ultrasonic information of the weld). Other display panels 16 may be used to display historical data regarding a particular weld to be inspected. For example, the other display panels 16 may illustrate historical data regarding weld size and weld information. It goes without saying, however, that any type of additional information may be displayed in these panels 14 and 16 without departing from the spirit and scope of the present teachings.

The optimization program also displays information such as the weld number to be inspected in a weld number display area 18. The weld corresponding to this weld number may also be highlighted in the graphic displayed in the main display panel 14. Additionally, the weld line and model number for that weld may be highlighted, and the device number that performs the weld will be displayed in a device display panel 20.

The program includes a button 22 that enables the inspector or user to toggle back and forth between a full-screen and small-screen view of the main display panel. The program also provides a button 26 that enables toggling back and forth between “Show Scan” and “Show Graphic.” Moreover, the program includes a weld stack-up information region 28 that displays whether the stack-up is either a 2 t or 3 t stack-up.

The program may also include various icons 30 for whether the inspection is to be a visual inspection, a chisel inspection, or an ultrasonic inspection method. These icons may be represented by the letters V, C, and U, respectively. The icon may be crossed with a prohibited symbol 32 if this is not an acceptable inspection method for that weld.

As stated above, the program provides display panels 16 that may display various historical data of the weld to be inspected. For example, one of the plurality of display panels 16 may depict a graph that charts the weld size over time, and another of the panels may depict a graph that charts the indentation of the weld. Alternatively, a graph that depicts a scan made by an ultrasonic device may be shown in one of the display panels 16.

Once the inspector has reviewed the above information, the inspector may inspect the weld prompted by the optimization program with the appropriate inspection technique (e.g., visually, ultrasonically, or chisel). After inspecting the weld, if using a remote weld analyzing device such as an ultrasonic inspection device that either is running the program of the present teaching or is coupled to a device such as a computer that is running the program of the present teachings, the inspector may then hit a “inspect” button 32. Pressing this button 32 will transfer the inspection information from weld analyzing device into the optimization program. Upon transfer of the inspection information, a new point may be plotted on the graphs shown in the display panels 16, or the appropriate scan may be viewed. The “Inspect” button 32 may be pressed as often as desired and the corresponding information will be re-plotted or shown each time the button 32 is pressed. When the information is plotted in the display panels 16, the newly plotted point may be displayed in a color that is different from the previously plotted points. For example, the newly plotted point may be blue.

The “Inspect” button 32 does not need to be pressed when checking the weld either visually or with a chisel. In such a case, the appropriate data for the graphic information may be input into the program manually, as desired. Regardless of the inspection method, the inspector may then press or click on either the “OK” or “Not OK” buttons 34 and 36. The inspector will touch these buttons 34 and 36 if the weld is either acceptable or unacceptable, respectively. If the weld is acceptable, the data point on the graphs may change from the, for example, blue color to a green color. In contrast, if the weld is unacceptable, the data point may change from the blue color to a red color. In addition to the data point changing to a red color, the program may also display a menu (not shown) that requires the inspector to select a reason why the weld is unacceptable. Exemplary reasons include whether the weld is undersized, merely sticking the substrates together, missing, has excessive indentation, or no reading was detected by the inspection device.

Once the inspector has finished checking the weld, the inspector may then hit the “forward” arrow button 38. The above method may then be repeated for the next weld number. A “back” arrow button 40 is also included should the inspector wish to review the previously inspected weld, or re-inspect an existing or new unit or assembly.

It should be understood that the optimization program enables the inspector, after inspecting the weld using one inspection method, to inspect the same weld using multiple inspection methods that may each be recorded in the system. For example, after checking the weld using a ultrasonic method, the inspector may choose to inspect the weld either visually, with a chisel, or with another inspection device such as a resistance spot weld analyzer. To prepare the program for this information, the inspector simply presses the appropriate icon 30 (V, C, or U) that represents the specific inspection method to be used.

Once the weld has been inspected using another method, this data may also be uploaded into the optimization program and plotted onto the appropriate graphs. If the weld is found acceptable such that the inspector hits the “OK” button 34, the plotted point may be represented by a green V, C, or U. In contrast, if the weld is found unacceptable such that the inspector hits the “Not OK” button 36, the plotted point may be represented by a red V, C, or U. Again, these letters are acronyms for the visual (V), chisel (C), and ultrasonic (U) methods described above. In this manner, a user inspecting the weld data will know what inspection methods were used and whether the result was acceptable or unacceptable by the color of the plotted letter.

As stated above, if the weld is found unacceptable, the program may require the inspector to select the reason why the weld was unacceptable from a menu (not shown) that includes whether the weld was undersized, whether the weld merely stuck the substrates together, whether the device had no reading, whether the weld was missing, and whether the weld had excessive indentation. If multiple inspection methods are used, as described above, these menus may be different for each of the inspection methods.

For example, for the chisel menu, the inspector may choose from whether the weld merely stuck the substrate together, missing, or undersized. The ultrasonic menu may include whether the weld was undersized, sticking, the device had no reading, the weld was missing, or whether the weld had excessive indentation. Lastly, the visual menu may include whether the weld had pinholes or cracks, distortion, excessive indentation, off-location, or missing.

Moreover, if a discrepant weld is found, it is contemplated that a screen (not shown) may appear with a list of all possible suspect welds (i.e., all welds from that same device, as well as a graphic showing the location of those discrepant welds). The inspector may then be prompted to inspect the suspect welds, or be prompted to communicate this information to an appropriate individual or group that will inspect the suspect welds.

Once this data has been entered, the inspector may then hit the “forward” arrow button 38. The inspector may then be prompted to input the model and weld line for the next unit to be inspected.

The inspector, as stated above, also has the opportunity at any time to go back to a weld he has already checked by hitting the “back” arrow button 40. If the inspector chooses to go back to a previous weld, the inspector may recheck the weld and, after hitting the “OK” or “Not OK” buttons 34 and 36 will be prompted to save additional information, overwrite, or cancel. In this manner, the appropriate data can be saved to the program. Further, if “Not Ok” is hit, a code may be generated that may be used on other devices by other inspection teams to inspect welds generated by that device. In this manner, any additional discrepant welds made by a particular device may be found and corrected in a timely fashion.

As stated earlier, a visual zone check may be prompted to occur periodically after a predetermined number of units. In this regard, the visual zone check may automatically suspend the in-line checking program and require the inspector to perform the visual zone check. During the visual zone check, the main display panel 14 may display a graphic with all welds highlighted in the zone that needs to be inspected. No graphs need to be shown in the other display panels 16, but the inspector is able to input the model and weld line. If all welds are deemed OK on visual inspection, the inspector may choose “OK,” then “Forward,” which brings him back into the in-line checking method described above.

If a weld is found to be discrepant during the visual zone inspection, the inspector will choose “Not OK.” A screen may then automatically appear prompting the inspector to input the weld number that was discrepant. After inputting the weld number, the inspector will be asked whether or not he wants to input any additional discrepant welds from the visual zone inspection. Further, similar to the in-line method described above, a screen may appear that lists all possible suspect welds (i.e. all welds made by the suspect device), as well as a graphic illustrating the location of the suspect welds. The inspector is then prompted to inspect these welds, or to communicate this information to the appropriate individual. After the suspect welds have been inspected, the inspector may then hit the “forward” arrow button to return to the in-line checking program.

In addition to the in-line and visual zone check methods described above, the optimization program of the present teachings also provides an off-line inspection method. The off-line inspection program may use a screen as shown in FIG. 6. Notwithstanding, the inspector may first log in to the system as shown in FIG. 2, and choose an inspection area. Once the program has loaded, the inspector may be prompted to input the unit number to be inspected. The inspector may also input the model and weld line information, as shown in FIG. 3.

The off-line program determines the weld that should be inspected, and the weld number will appear on the screen 19 at welding region 18. Further, a graphic showing the weld number may also appear in main display panel 14. In addition, historical data, graphs, device number, and substrate stack-up data may also be shown. If the inspector is inspecting units from multiple production lines, the weld line may be selected by the inspector before the weld appears on the screen. In this regard, the weld line may be highlighted on the screen.

Subsequently, the inspector may check the first weld on the unit. After performing all the inspections, the inspector may hit the “forward” button, which will bring up the next scheduled weld to be inspected. The inspector may then continue inspecting welds on the unit or panel. Once finished inspecting the unit, the inspector may then hit a button entitled “Next Unit.” Then, the inspector may be prompted to input the next model number, unit number, and weld lines.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of inspecting welds, comprising:
sorting a plurality of welds according to predetermined weld criteria;
organizing an inspection routine after sorting said plurality of welds; and
inspecting the welds according to the inspection routine.

2. The method of claim 1, wherein said weld criteria includes a model number.

3. The method of claim 1, wherein said weld criteria includes a weld number on a unit.

4. The method of claim 1, wherein said weld criteria includes a weld device that made the welds.

5. The method of claim 1, wherein said weld criteria includes a weld schedule of a weld device.

6. The method of claim 1, wherein said weld criteria includes a weld classification.

7. The method of claim 1, wherein said weld criteria includes a substrate thickness.

8. The method of claim 1, wherein said step of sorting said plurality of welds includes driving a unit that includes said welds into a plurality of zones, and sorting said welds according to their location in said zones.

9. The method of claim 1, further comprising tracking information related to inspection of said welds.

10. The method of claim 1, wherein said inspection step includes visually inspecting said welds, inspecting said welds with a chisel, or using a weld inspection tool to inspect said welds.

11. The method of claim 1, wherein said step of sorting said welds including first prioritizing said welds according to a plurality of weld devices that said welds are produced on, then according to a weld schedule of said weld device, and then according to a weld number.

12. The method of claim 8, further comprising inspecting at least one weld made by each welding device.

13. The method of claim 9, wherein after inspecting at least one weld made by each welding device, inspecting at least one weld made at a different weld schedule by each welding device.

14. The method of claim 1, further comprising inspecting every weld made by a welding device if a discrepant weld is found.

15. The method of claim 8, further comprising after a predetermined number of welds have been inspected, inspecting each weld located in at least one zone.

16. The method of claim 1, wherein said inspecting step may be performed in-line or off-line.

17. The method of claim 1, wherein said sorting step is done with a computer, a remote device, or a weld analyzing device.

18. A method for inspecting welds comprising:
sorting a plurality of welds to be inspected according to a weld device that made the welds;
after sorting the welds according to the weld device that made the welds, sorting the welds according to a plurality of weld schedules of the weld device that made the welds;
after sorting the welds according to the weld schedules, sorting the welds according to a weld number;
inspecting at least one weld made by each weld device; and
repeating said inspecting step until the plurality of welds made by each weld device at each weld schedule is completed.

19. The method of claim 18, further comprising, after the sorting steps, forming an inspection routine.

20. The method of claim 19, wherein said inspection routine is formed by a computer, a remote device, or a weld inspection tool.
